(19) United States
(12) Patent Application Publication
(10) Pub. No.: US 2015/0296084 A1
(43) Pub. Date: Oct. 15, 2015

(54) TRANSFERRING AN CALLS TO AN ACTIVE DEVICE WITHIN A HOME CLOUD

(71) Applicant: Nokia Technologies Oy, Espoo (FI)

(72) Inventor: Vicente Calvo Alonso, Piispanristi (FI)

(21) Appl. No.: 14/437,473

(22) PCT Filed: Nov. 2, 2012
(86) PCT No.: PCT/US2012/063349

§ 371 Date: Apr. 21, 2015

(51) Int. Cl. H04M 3/54; H04L 29/06; H04M 3/42

(52) U.S. Cl. CPC H04M 3/54; H04M 3/42246; H04L 65/1083; H04L 65/1096; H04M 3/42263; H04W 84/12

(57) ABSTRACT

Method and apparatus for transferring calls in a home cloud to a user equipment that is currently in use. The home cloud is a wireless local network using WiFi or Bluetooth. The method includes receiving, at a first user equipment, a call made via a cellular network to a subscriber identity associated with the first user equipment; and routing, by the first user equipment, the call to a second user equipment to enable the second user equipment to answer the call received from a cellular network. The second user equipment being designated by a controller of a wireless local area network as an active device or in use within the wireless local area network which enables the first user equipment to forward the call to the second user equipment which is more convenient for the user to receive the call.

### FIELD

The subject matter disclosed herein relates to wireless communications.

### BACKGROUND

Cloud computing may refer to sharing resources, such as storage, printing, applications, and the like, among a plurality of computers coupled via a network, such as the Internet, a home wireless network, and the like. For example, a server on the cloud may provide a print service to the computers of the cloud or may provide an application/service, such as a word processing application, and the like.

### SUMMARY

Methods and apparatus, including computer program products, are provided for transferring calls in a home cloud.

In some example embodiments, there is provided a method. The method may include receiving, at a first user equipment, a call made to a subscriber identity associated with the first user equipment; and routing, by the first user equipment, the call to a second user equipment to enable the second user equipment to answer the call received from a cellular network, the second user equipment being designated by a controller of a wireless local area network as an active device within the wireless local area network.

In some example embodiments, one of more variations may be made as well as described in the detailed description below and/or as described in the following features. The wireless local area network may comprise a home cloud network including the first user equipment and the second user equipment, and wherein the home cloud network allows the first user equipment and the second user equipment to share one or more services available on the home cloud network. The second user equipment may be designated as the active device based on at least an indication of activity by a user of the second user equipment, wherein the second user equipment lacks an authenticator to directly access the cellular network. The designating may further include detecting the indication comprising one or more of the following: a touch screen touch at the second user equipment, a key pad selection at the second user equipment, a screen light being activated at the second user equipment, and data being sent to, or being received from, the cellular network. The second user equipment may be designated as an idle device based on at least a lack of activity for a predetermined period of time. The call may be answered, after the routing, at the second user equipment, rather than at the first user equipment. The controller may monitor whether a plurality of user equipment in the wireless local area network change modes between an active mode and an idle mode to enable the controller to designate at least one of the plurality of user equipment as the active device. The routing may further comprise forwarding the call to the second user equipment via at least one of a direct path and an indirect path, wherein the direct path comprises a wireless link directly between the first user equipment and the second user equipment, and the indirect path comprises a plurality of links via at least one other device.

It is to be understood that both the foregoing general description and the following detailed description are exemplary and explanatory only and are not restrictive. Further features and/or variations may be provided in addition to those set forth herein. For example, the implementations described herein may be directed to various combinations and subcombinations of the disclosed features and/or combinations and subcombinations of several further features disclosed below in the detailed description.

### DESCRIPTION OF THE DRAWINGS

The accompanying drawings, which are incorporated in and constitute a part of this specification, show certain aspects of the subject matter disclosed herein and, together with the description, help explain some of the principles associated with the subject matter disclosed herein. In the drawings,

FIGS. 1A, 1B, and 1C depict examples of home clouds, in accordance with some example embodiments;

FIG. 2 depicts example of a process for transferring a call to a device actively being used, in accordance with some example embodiments;

FIG. 3 depicts another example of a process for transferring a call to a device actively being used, in accordance with some example embodiments;

FIG. 4 depicts an example of a system including the home cloud, in accordance with some example embodiments;

FIG. 5 depicts an example of a radio, in accordance with some example embodiments; and

FIG. 6 depicts an example of an access point, in accordance with some example embodiments.

Like labels are used to refer to same or similar items in the drawings.

### DETAILED DESCRIPTION

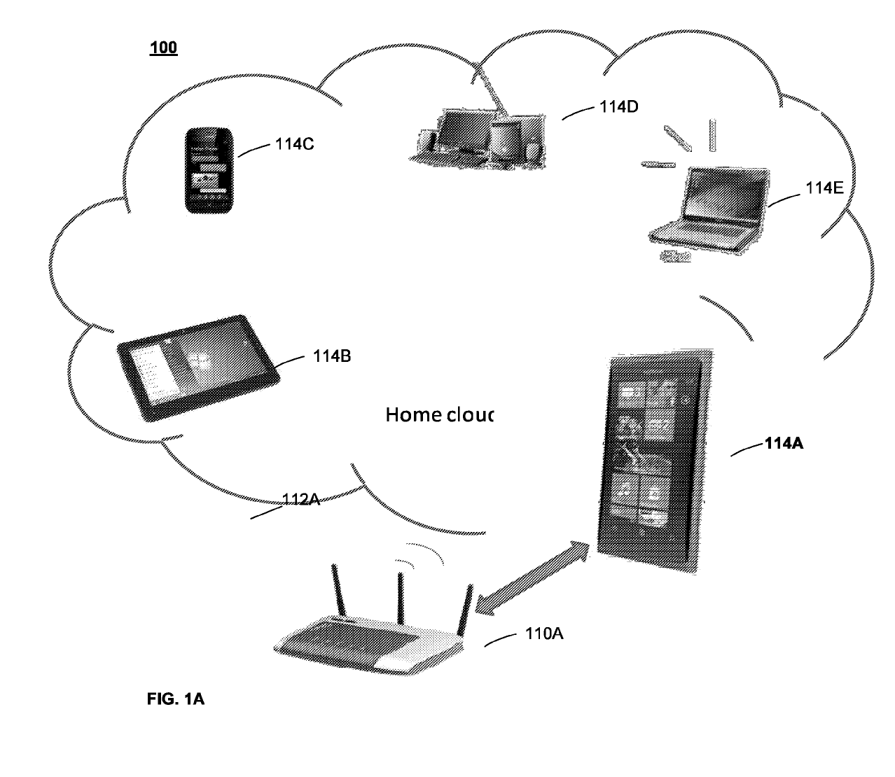

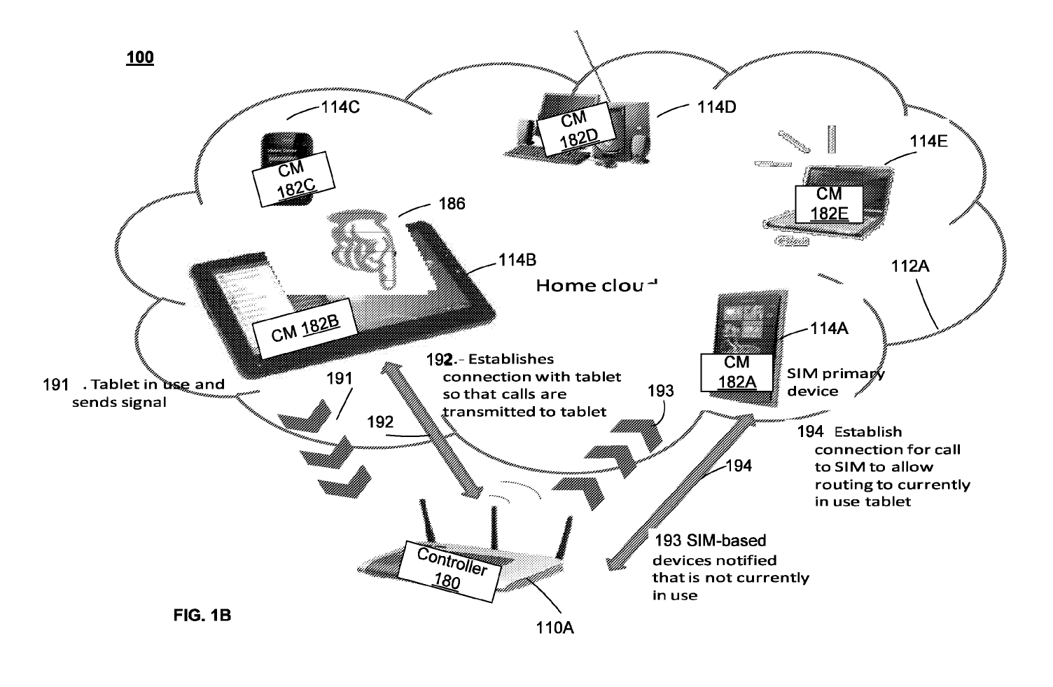

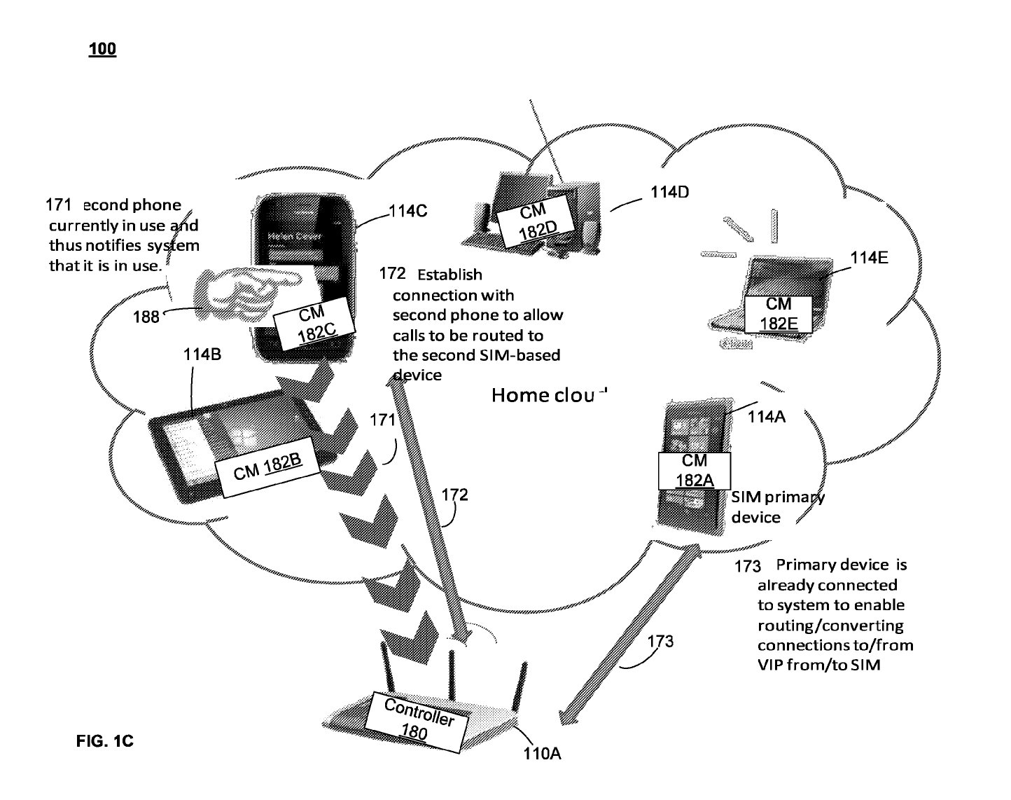

FIG. 1A depicts a system 100 including one or more user equipment 114A-E being served by a wireless access point 110A serving a coverage area 112A. The coverage area 112A may form a so-called “home cloud” 112A. The home cloud may provide a wireless local area network covering a relatively small region, such as a home, a structure, and the like. The user equipment 114A-E in the home cloud 112A may share resources, such as printing, software, processing, resources, storage, network access, and any other service. Moreover, system 100 may be configured so that each of the user equipment 114A-E may be granted permission to access the home cloud 112A including the resources therein.

In some example embodiments, at least one user may access at least one of the user equipment 114A-E. For example, a user may actively use user equipment 114A at a first time, and then later at a second time actively use user equipment 114B, and then again at a third time actively use user equipment 114C, and so forth. To illustrate further, user equipment 114A-E may be associated with a user and during the day the user may actively use different devices throughout the day. As such, the user equipment actively being used at any given instant of time may vary over time.

The subject matter described herein may relate to controlling system 100, such that a call from a public land mobile network made to a user equipment is directed to whatever user equipment on the home cloud is actively being used when the call is received. Active use may comprise one or more of the following: detecting interaction at a user interface, such as a touch screen, a key pad, and the like, at a user equipment; detecting a user equipment's screen light being activated; sending user data to, or receiving data from, the network; detecting motion via a transducer, a motion detector, a geolocation processor, and the like; and/or any other indication that a user is currently using a user equipment.

The following provides an example of a user that is actively using user equipment 114B. The system 100 may designate user equipment 114B as the device currently in active use. When a call from a public land mobile network is received at system 100, the call may be directed to a subscriber identity, such as an International Mobile Subscriber Identity (IMSI) and the like associated with an authenticator, such as a subscriber identity module (SIM) at user equipment 114A. Specifically, system 100 may receive the call and then process the call so that user equipment 114B can handle the call (for example, by converting the call at user equipment 114A to a voice over internet protocol call (VOIP) and forwarding the VOIP call to user equipment 114B). In this example, user equipment 114B may not include a SIM and/or the capability to make calls directly to a public land mobile network, such as a cellular network. Furthermore, when user equipment 114B makes a call to the public land mobile network and, ultimately, to a called party, system 100 may process the outgoing call so that the outgoing call is made via user equipment 114A which contains the SIM. In the example of FIG. 1A, system 100 can receive calls at any of the devices on the home cloud despite user equipment 114B-E not having a SIM (and/or other credentials) to make calls to a public land mobile network/cellular network so long as at least one of the devices, such as user equipment 114A, includes a SIM.

FIG. 1B depicts another example implementation of system 100 but further depicts controller 180 at wireless access point 180 and connection managers 182A-E at each of the user equipment 114A-E.

In some example embodiments, the controller 180 may be configured to manage call transfer processing at system 100 from a user equipment having a SIM to another user equipment which is designated as the currently active device from a user interaction perspective.

Moreover, the controller 180 may perform one or more of the following operations: monitor what user equipment 114A-E within the home cloud 112A is currently in active use; designate at least one user equipment as the active device; designate at least one user equipment as a primary device having a subscriber identity or SIM allowing calls to/from a public land mobile network/cellular network; receive messages from a user equipment indicating active use by a user; grant permission to a user equipment to access the home cloud 112A; initiate connection establishment to the user equipment currently designated as the active device; initiate connection establishment to the user equipment, designated as the primary device (e.g., user equipment 114A) containing the SIM, to allow making calls to/from a public land mobile network/cellular network; convert a call for a user equipment including the SIM into a format compatible with the user equipment in the home cloud currently in active use; convert a call from the currently active user equipment in the home cloud into a format compatible with the primary device, such as user equipment 114A including the SIM; route calls to, and from, the user equipment currently in active use; and the like. The controller 180 may, in some example embodiments, be implemented as a server (e.g., a processor including memory) coupled to, for example, a wireless access point and/or a device in the home cloud, although the controller 180 may be implemented in other ways as well.

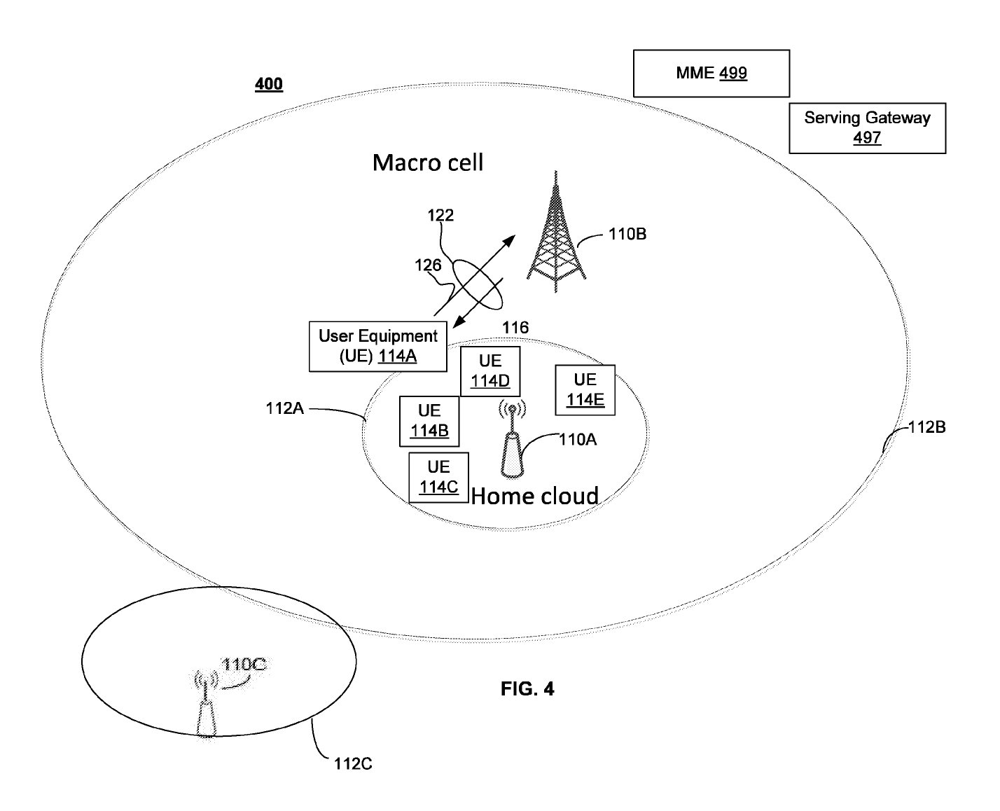

Although FIG. 1B depicts controller 180 at wireless access point 110A, controller 180 may be located at any other device, such as at a user equipment, a network node, and the like. Moreover, controller 180 may be distributed among a plurality of devices/user equipment/network nodes as well. In addition, any of the user equipment 114A-E may, in some example embodiments, be designated as the controller 180. Furthermore, the user equipment 114A-E may be polled to ask whether the user equipment is capable or willing of serving as the controller 180A. And, the controller 180 may be located in another network as well. For example, the controller 180 may be located in a node of the public land mobile network, as described further below with respect to FIG. 4.

The connection managers 182A-E may, in some example embodiments, comprise code installed on the user equipment to enable interaction with controller 180. Moreover, the connection manager 182B may, in some example embodiments, perform one or more of the following operations: monitor a user equipment in the home cloud for active use; prompt a user for an access code (e.g., user name and/or password); register a user equipment in the home cloud with the controller 180; send a message to controller 180 indicating that a user equipment is currently in active use; receive messages from controller 180; and/or initiate connection establishment to controller 180 to allow a call to be received from, or sent to, a primary device, such as user equipment 114A (which contains a SIM), and the public land mobile network. Furthermore, a connection manager may send a message indicating when a user equipment is no longer in active use, such as when the user equipment is idle. Connection manager 182A may signal to controller 180 that user equipment 114A includes a SIM, so it can handle calls to, or from, a public land mobile network/cellular network on behalf of the plurality of user equipment 114B-E coupled to home cloud 112A. Furthermore, the one or more connection managers 182A-E may, in some example embodiments, be configured to perform one or more of the operations disclosed herein with respect to the controller 180.

To illustrate further, the following provides an example. A user may access a user interface, such as a key board, a touch screen, and the like, at user equipment 114B. In this example, connection manager 182B may detect active use in the form of a touch 186 of a touch screen at user equipment 114B, although other indications of active use may be detected as well. The connection manager 182B may then send a message at 191. The message may include an indication of active use, a time of the active use, and/or an identity (e.g., an Internet Protocol (IP) address, Media Access Control (MAC) address, a subscriber identity, an IMSI, a phone number, and the like) of user equipment 114B. The controller 180 may then receive the message and designate user equipment 114B as the active device currently in use. The controller 180 may send an acknowledgment message to user equipment 114B, and connection manager 182B may designate user equipment 114B as currently in active use. This acknowledgement may be implicit. For example, the controller 180 may acknowledge by establishing at 192 a connection to user equipment 114B to enable calls to be routed to, or from, user equipment 114B.

Other devices may send messages to controller 180 indicating whether they are currently in use. For example, controller 180 may at 193 send to user equipment 114A a message to connection manager 182A to indicate that user equipment 114A is not currently in use.

User equipment 114A as the primary device having a SIM may establish a connection at 194 to controller 180, so that when a call is received at user equipment 114A from the public land mobile network the call is routed to the device currently designated by the controller 180 as currently in active use. As such, the user can pick up the call at user equipment/tablet 114B, rather than change devices to access user equipment 114A.

In some example embodiments, the controller 180 may reconcile which device is currently in use. For example, if controller 180 receives messages at about the same time from a plurality of user equipment, the controller may reconcile which device is currently in use. In some example embodiments, the controller 180 may select one of the plurality of user equipment and send a message notifying the selected one of the user equipment that it is currently in use (and send other messages to the user equipment not selected indicating that they have not been selected as the device currently in use). The controller 180 may also select a plurality of user equipment as being currently in use, in which case the plurality of user equipment may be notified and receive (or make) calls via the primary device, such as user equipment 114A to the public land mobile network.

In some example embodiments, user equipment 114A including connection manager 182A may send a message to controller 180 to indicate that user equipment 114A includes a SIM and, as such, can be designated as a primary device able to receive and send calls to the public land mobile network on behalf of the other user equipment 114B-E in home cloud 112A.

In some example embodiments, the controller 180 may convert calls into a format compatible for a destination device. For example, if the call is received from a public land mobile network as a cellular call, the controller 180 may convert the call into another format, such as VOIP, and then forward the call as a VOIP call for handling by user equipment 114B designated as currently in active use, such that a user may access the call and interact with the calling party at user equipment 114B.

In some example embodiments, the conversion of the call into a VOIP call may be done at other locations, and formats other than VOIP may be used as well. Moreover, the conversion may not be performed. For example, if the active device is also the primary device containing the SIM, then conversion to VOIP is not necessary. Furthermore, although the previous example describes the connections 192 and 194 between user equipment 114A (the primary device) and user equipment 114B (the device currently in active use) via wireless access point 110A, user equipment 114A and user equipment 114B may establish direct connections for call handling as well.

FIG. 1C depicts system 100 with user equipment 114C configured as a phone rather than a tablet. Moreover, the user equipment 114C may not include a SIM, so calls may be made via a protocol such as VOIP.

At 171, user equipment 114C including connection manager 182C may send to controller 180 a message indicating that user equipment 114C is currently in active use, in accordance with some example embodiments. This message may include a current time (e.g., time stamp) and/or an identity of user equipment 114C.

The controller 180 may then respond to user equipment 114C with an acknowledgment and/or an initiation at 172 of a connection between the wireless access point 110A and user equipment 114C. This connection may be used to carry calls received by the primary device (which is user equipment 114A in this example) on behalf of home cloud 112A.

When the call is received at user equipment 114A from the public land mobile network, user equipment 114A, as the primary device having a SIM, may establish a connection at 173 to controller 180, where the call may be processed, routed, and/or converted before being carried to user equipment 114C. As such, the user can pick up the call at user equipment 114C rather than change devices by accessing user equipment 114A.

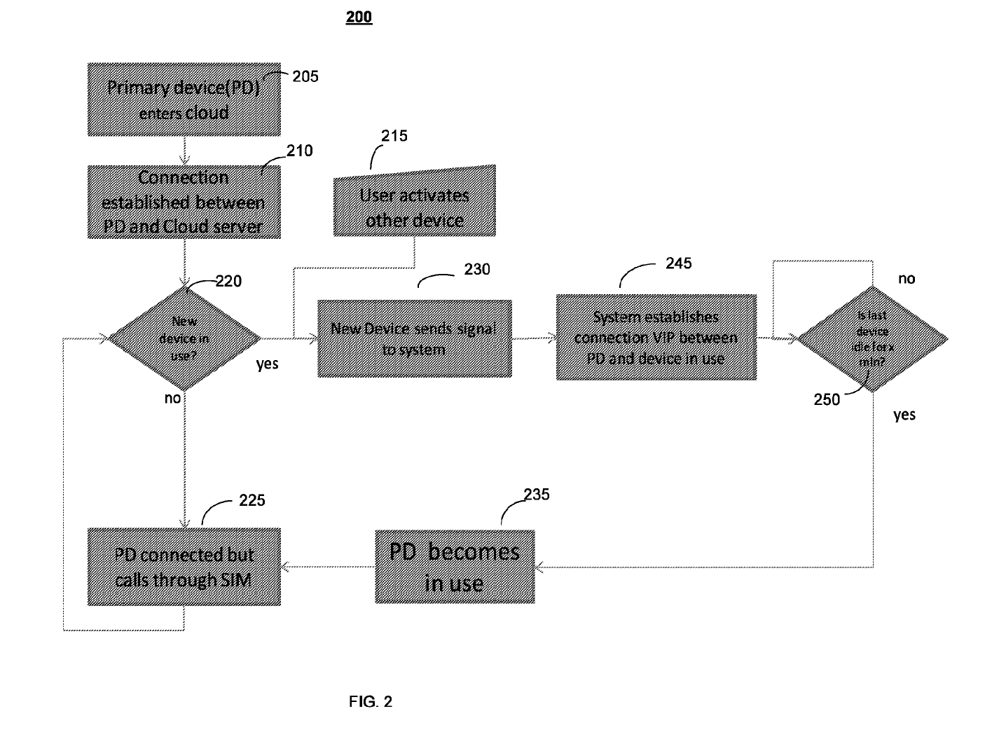

FIG. 2 depicts an example process 200, in accordance with some example embodiments. The description of process 200 may also refer to FIGS. 1A-1C.

At 205, a primary device may enter a home cloud, in accordance with some example embodiments. For example, user equipment 114A containing a SIM may enter the coverage area of home cloud 112A. When user equipment 114A enters home cloud 112A, user equipment 114A may programmatically detect the home cloud 112A and attempt to connect to home cloud 112A including wireless access point 110A and controller 180. During the connection process, controller 180 may grant access and assign credentials, such as a password, a login identifier, and/or the like. Moreover, controller 180 may designate user equipment 180 as the primary device, which will handle calls to and/or from the public land mobile network/cellular network on behalf of the home cloud 112A. In some example embodiments, controller 180 may select a single device as a primary device, although a plurality of devices may be selected as well. Moreover, the controller 180 may base the selection of a primary device on one or more factors, such as capabilities of the device, calling plans associated with the primary device (e.g., fees associated with calls), acquiescence by user, and the like.

At 210, a connection may be established between the primary device and the controller, in accordance with some example embodiments. For example, a connection may be established between user equipment 114A, designated as the primary device, and controller 180, which in the example of FIG. 1B-C is located at wireless access point 110A, although controller 180 may be located at any other location as well (including at the currently active device and/or the primary device). The connection may be implemented as at least one wireless link, and the at least one wireless link may be in accordance with a WiFi, although other technologies may be used as well. For example, the wireless link may be implemented in accordance with Bluetooth, Bluetooth low energy, near field communications, and/or any other radio standard or technology. Moreover, the connection may be configured as an IP connection, although other connection types and/or protocols may be used as well.

When a user actively uses a device, the new device may be detected as currently being in active use at 215-220, in accordance with some example embodiments. For example, when a user selects a touch screen at user equipment 114B, user equipment may send, at 230, a message to controller 180 to indicate that user equipment 114B is currently in active use by a user.

At 245, controller 180 may then establish a connection to the user equipment in active use to allow calls to be received at, or sent by, the active user equipment, in accordance with some example embodiments. For example, a connection may be established between the primary device, which is user equipment 114A, and the active device, which is user equipment 114B. The connection may be a direct connection between the primary device and the active device (e.g., direct connection between user equipment 114A and 114B), although the connection may be via other user equipment and/or wireless access point 110A as well. As long as the currently active device remains active, any calls received by the primary device, such as user equipment 114A, may be transferred to the active device, such as user equipment 114B.

At 250, if the active device becomes idle, the controller 180 and/or a connection manager at the device may detect the idle mode, in accordance with some example embodiments. For example, if user equipment 114B is idle for a predetermined time period, the connection manager 180B may signal controller 180 that user equipment 114B is idle. An idle state may be detected in a variety of ways. For example, one or more of the following conditions may be detected to determine that the device is not currently in active use (e.g., idle): a touch screen or a display going dark; a lack of user data being sent to or received from the device for a predetermined time; no movement for a predetermined time as detected by a motion sensor or transducer; no user interface activity for a predetermined time; and/or any other indication that a user is not interacting with or using a user equipment.

When the user equipment, such as user equipment 114B, is in idle mode, controller 180 may no longer consider user equipment 114B as being in active use and may designate the device as idle and/or disconnect the connections to/from the idle device. The system 100 may be configured with, for instance, an idle mode option, so that if an idle mode is detected (e.g., no use for a predetermined time), the controller 180 designates the primary device, such as user equipment 114A, as the currently active device, as depicted at 235, until another device in the cloud becomes active. At 225, the primary device, such as user equipment 114A containing the SIM, may then be used to send and/or receive calls to the public land mobile network and, ultimately, a destination party, in accordance with some example embodiments.

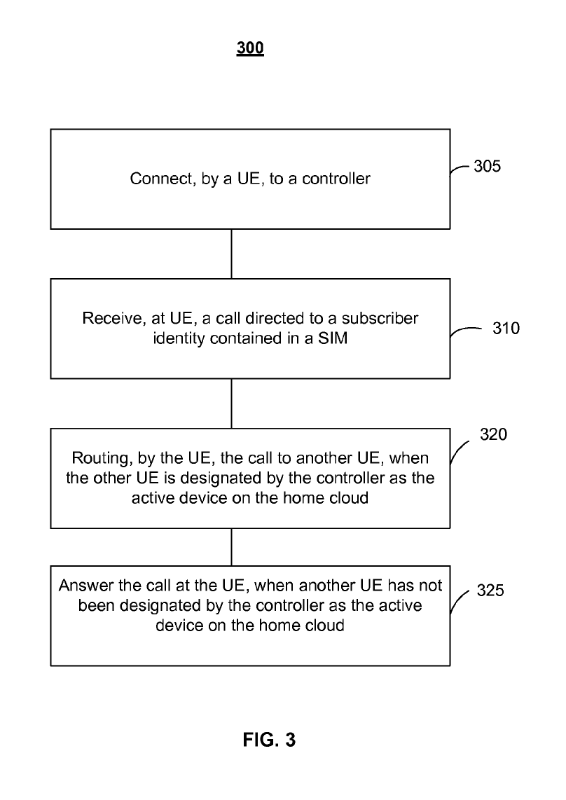

FIG. 3 depicts an example process 300 in accordance with some example embodiments. The description of process 300 may also refer to FIGS. 1A-1C.

At 305, a user equipment may connect to a controller, in accordance with some example embodiments. For example, user equipment 114A including connection manager 182A may wirelessly connect to controller 180 via WiFi, although other types of radio access technologies may be used as well. User equipment 114A may also provide an indication that it can serve as a primary device to receive, and/or send calls, on behalf of other user equipment/devices on home cloud 112A.

At 310, the user equipment 114A may receive a call directed to a subscriber identity (which may be contained in the SIM at user equipment 114A), in accordance with some example embodiments. For example, a caller may make a call to an IMSI contained at the SIM of user equipment 114A. The call may traverse at least the public land mobile network/cellular network.

At 320, the user equipment 114A may route the received call to another user equipment designated as the active device in the home cloud, so that the other device can answer the call, in accordance with some example embodiments. In some example embodiments, the connections may be pre-established from the primary device, such as user equipment 114A, and the device currently in active use, such as user equipment 114B. As such, when the call is received at 320, the call may be routed directly to the device currently in active use (although some processing may be required if for example conversions is required into another format, such as VOIP). In some example embodiments, the connections are not pre-established. Instead, the primary device, such as user equipment 114A, notifies the controller 180, which responds to user equipment 114A with the address of the device currently in active use. In response to this notification, the connection(s) may then be established between the device currently in active use, such as user equipment 114B, and the primary device, such as user equipment 114A.

In some example embodiments, if there is no device other than the primary device designated as the active device in the home cloud, the primary device may be designated the device currently in active use (so the call is merely answered at the primary device).

Although the previous examples refer to calls being transferred, the transfer process described with respect to FIGS. 2 and 3 may also handle other types of services, such as emails, video conferences, push-to-talk, texting, and the like.

Before providing additional examples, the following provides an example of a system framework in which some of the example embodiments described herein may be implemented.

FIG. 4 depicts a system 400 including user equipment 114A-E, wireless access points 110A-C, and coverage areas (also referred to as cells) 112A-C.

The home cloud 112A is depicted as a small cell within macro cell 112B, although other cell configurations and types may be used as well. Moreover, user equipment 114A is coupled to a wireless access point comprising a base station 110B of a public land mobile network/cellular network. System 400, including one or more of the wireless access points 110A-C, may include wired and/or wireless backhaul links to other network nodes, such as a mobility management entity (MME) 499, other base stations, a radio network controller, a core network, a serving gateway 497, and the like. In some example embodiments, the controller 180 may be located in a network node, such as MME 499, and MME 499 may comprise at least one processor and at least one memory including code which when executed by the at least one processor causes operations described herein with respect to those devices.

In some example embodiments, the user equipment, such as user equipment 114A-E, may be implemented as a mobile and/or a stationary device. The user equipment may be referred to as, for example, mobile stations, mobile units, subscriber stations, wireless terminals, tablets, smart phones, or the like. The user equipment may be implemented as, for example, a wireless handheld device, a wireless plug-in accessory, or the like. In some example embodiments, the user equipment may include one or more processors, one or more computer-readable storage medium (for example, memory, storage, and the like), one or more radio access components (for example, a modem, a transceiver, and the like), and/or a user interface.

In some example embodiments, the user equipment, such as user equipment 114A-E, may be implemented as multi-mode user devices configured to operate using a plurality of radio access technologies, although a single-mode device may be used as well. For example, user equipment 114A-E may be configured to operate using a plurality of radio access technologies including one or more of the following: Long Term Evolution (LTE), wireless local area network (WLAN) technology, such as 802.11 WiFi and the like, Bluetooth, Bluetooth low energy (BT-LE), near field communications (NFC), and any other radio access technologies. Moreover, the user equipment 114A-E may each be configured to establish connections to other devices, such as other access points, user equipment, and the like, using a plurality of the radio access technologies.

One or more of the wireless access points 110A-C may comprise base stations, and, in some example embodiments, the base stations may be implemented as an evolved Node B (eNB) type base station, although other types of wireless access points may be implemented as well. When the evolved Node B (eNB) type base station is used, the base stations may be configured in accordance with standards, including the Long Term Evolution (LTE) standards, such as 3GPP TS 36.201, Evolved Universal Terrestrial Radio Access (E-UTRA); Long Term Evolution (LTE) physical layer; General description, 3GPP TS 36.211, Evolved Universal Terrestrial Radio Access (E-UTRA); Physical channels and modulation, 3GPP TS 36.212, Evolved Universal Terrestrial Radio Access (E-UTRA); Multiplexing and channel coding, 3GPP TS 36.213, Evolved Universal Terrestrial Radio Access (E-UTRA); Physical layer procedures, 3GPP TS 36.214, Evolved Universal Terrestrial Radio Access (E-UTRA); Physical layer—Measurements, and any subsequent additions or revisions to these and other 3GPP series of standards (collectively referred to as LTE standards).

One or more of the wireless access points 110A-C may also be configured to serve small cells, such as pico cells, femto cells, home cells, and the like. For example, wireless access point 110A may be implemented as a femto cell base station serving small cell 112A or may be implemented using WLAN technology, such as WiFi (for example, the IEEE 802.11 series of standards), although any other radio access technology may be used as well.

In some example embodiments, system 400 may include access links, such as links 122, between the base station and user equipment. For example, access links 122 may include a downlink 116 for transmitting to user equipment 114A and an uplink 126 for transmitting from user equipment 114A to the base station 1108. The downlink 116 may comprise a modulated radio frequency carrying information, such as user data, radio resource control (RRC) messages, and the like, to the user equipment 114A, and the uplink 126 may comprise a modulated radio frequency carrying information, such as user data, RRC messages, and the like, from the user equipment 114A to base station 1108. The downlink 116 and uplinks 126 may, in some example embodiments, each represent a radio frequency (RF) signal. The RF signal may, as noted above, carry data, such as voice, video, images, Internet Protocol (IP) packets, control information, and any other type of information and/or messages. For example, when LTE is used, the RF signal may use OFDMA. OFDMA is a multi-user version of orthogonal frequency division multiplexing (OFDM). In OFDMA, multiple access is achieved by assigning, to individual users, groups of subcarriers (also referred to as subchannels or tones). The subcarriers are modulated using BPSK (binary phase shift keying), QPSK (quadrature phase shift keying), or QAM (quadrature amplitude modulation), and carry symbols (also referred to as OFDMA symbols) including data coded using a forward error-correction code. The subject matter described herein is not limited to application to OFDMA systems, LTE, LTE-Advanced, WiFi, or to the noted standards, specifications, and/or technologies.

Although FIG. 4 depicts a specific quantity and configuration of base stations, cells, and user equipment, other quantities and configurations of devices may be implemented as well.

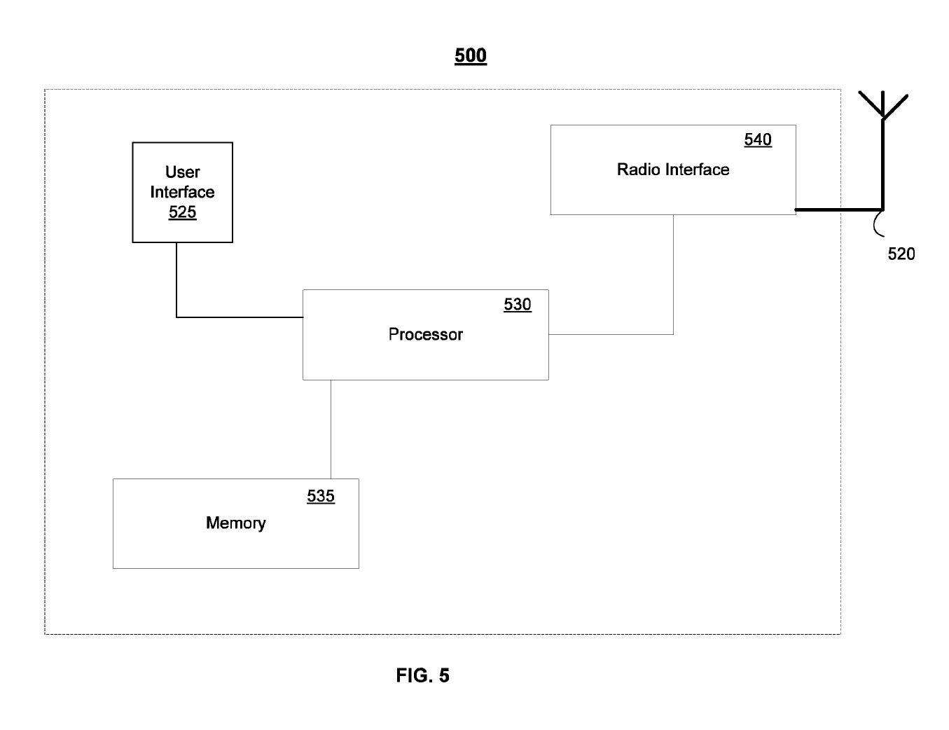

FIG. 5 depicts a block diagram of a radio 500 that may be used at user equipment 114A-E, in accordance with some example embodiments. The user equipment may include one or more antennas 520 for receiving a downlink and transmitting via an uplink. The user equipment 500 may also include a radio interface 540 (also referred to as a modem) coupled to the antenna 520. The radio interface 540 may correspond to a plurality of radio access technologies including one or more of LTE, WLAN, Bluetooth, BT-LE, NFC, RFID, UWB, ZigBee, and the like. The radio interface 540 may include other components, such as filters, converters (for example, digital-to-analog converters and the like), symbol demappers, signal shaping components, an Inverse Fast Fourier Transform (IFFT) module, and the like, to process symbols, such as OFDMA symbols, carried by a downlink or an uplink. The user equipment 500 may further include a user interface 525, at least one processor, such as processor 530, for controlling user equipment 500 and for accessing and executing program code stored in memory 535. In some example embodiments, the memory 535 includes code, which when executed by at least one processor causes one or more of the operations described herein with respect to user equipment, such as process 200, process 300, and the like. For example, the user equipment (including the processor) may perform one or more of the following operations: receive a call made to a subscriber identity associated with a first user equipment; route a received call to a second user equipment (designated by a controller of a home cloud network as an active device) to enable the second user equipment to answer the received call; and/or perform any other operations associated with the user equipment disclosed herein.

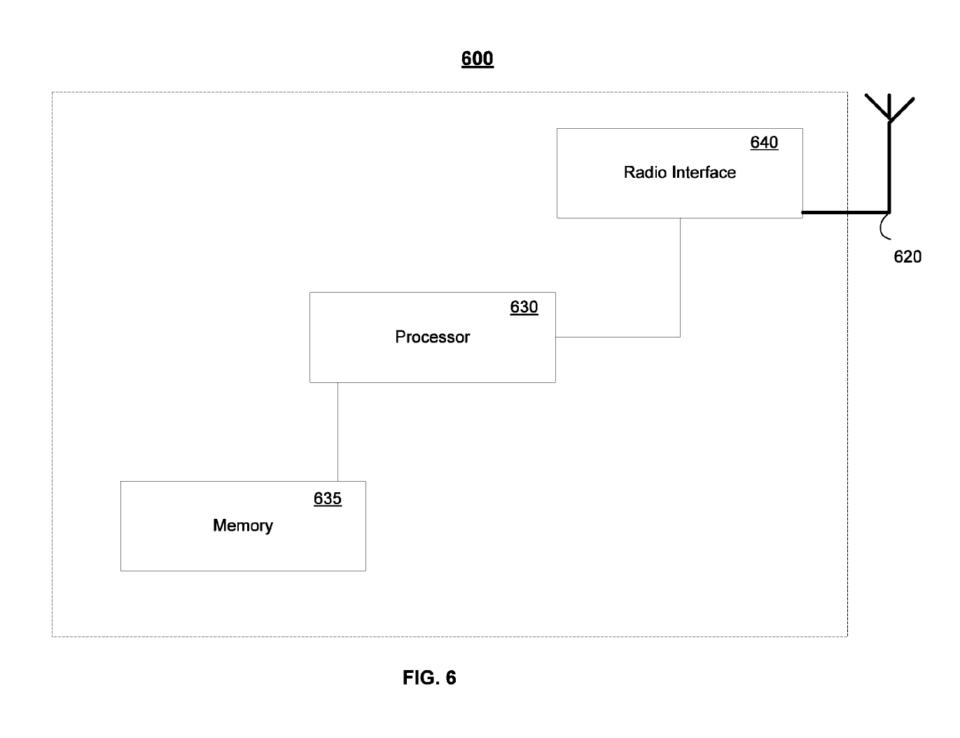

FIG. 6 depicts an example implementation of a wireless access point 600, which may be implemented at wireless access points 110A-C, in accordance with some example embodiments. The wireless access point may include one or more antennas 620 configured to transmit via a downlink and configured to receive uplinks via the antenna(s) 620. The access point may further include a plurality of radio interfaces 640 coupled to the antenna 620. The radio interfaces may correspond to a plurality of radio access technologies including one or more of LTE, WLAN, Bluetooth, BT-LE, NFC, radio frequency identifier (RFID), ultrawideband (UWB), ZigBee, and the like. The access point may further include one or more processors, such as processor 630, for controlling the access point 600 and for accessing and executing program code stored in memory 635. In some example embodiments, the memory 635 includes code, which when executed by at least one processor causes one or more of the operations described herein with respect to an access point. The radio interface 640 may further include other components, such as filters, converters (for example, digital-to-analog converters and the like), mappers, a Fast Fourier Transform (FFT) module, and the like, to generate symbols for a transmission via one or more downlinks and to receive symbols (for example, via an uplink). Furthermore, the access point 600 may be configured to perform any other operations associated with the access point disclosed herein.

Without in any way limiting the scope, interpretation, or application of the claims appearing herein, a technical effect of one or more of the example embodiments disclosed herein may, in some example implementations, comprise allowing devices without SIMs on a home cloud to make or receive calls to a public land mobile network.

Although some of the examples refer to a SIM, any other authentication mechanism, such as a Universal Integrated Circuit Card and the like, may be used that authenticates the device to the public land mobile network in order to make and receive calls.

The subject matter described herein may be embodied in systems, apparatus, methods, and/or articles depending on the desired configuration. For example, the base stations and user equipment (or one or more components therein) and/or the processes described herein can be implemented using one or more of the following: a processor executing program code, an application-specific integrated circuit (ASIC), a digital signal processor (DSP), an embedded processor, a field programmable gate array (FPGA), and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device. These computer programs (also known as programs, software, software applications, applications, components, program code, or code) include machine instructions for a programmable processor, and may be implemented in a high-level procedural and/or object-oriented programming language, and/or in assembly/machine language. As used herein, the term “computer-readable medium” refers to any computer program product, machine-readable medium, computer-readable storage medium, apparatus and/or device (for example, magnetic discs, optical disks, memory, Programmable Logic Devices (PLDs)) used to provide machine instructions and/or data to a programmable processor, including a machine-readable medium that receives machine instructions. Similarly, systems are also described herein that may include a processor and a memory coupled to the processor. The memory may include one or more programs that cause the processor to perform one or more of the operations described herein.

Although a few variations have been described in detail above, other modifications or additions are possible. In particular, further features and/or variations may be provided in addition to those set forth herein. Moreover, the implementations described above may be directed to various combinations and subcombinations of the disclosed features and/or combinations and subcombinations of several further features disclosed above. Other embodiments may be within the scope of the following claims.

The different functions discussed herein may be performed in a different order and/or concurrently with each other. Furthermore, one or more of the above-described functions may be optional or may be combined. Although various aspects of the invention are set out in the independent claims, other aspects of the invention comprise other combinations of features from the described embodiments and/or the dependent claims with the features of the independent claims, and not solely the combinations explicitly set out in the claims. It is also noted herein that while the above describes example embodiments of the invention, these descriptions should not be viewed in a limiting sense. Rather, there are several variations and modifications which may be made without departing from the scope of the present invention as defined in the appended claims. The term “based on” includes “based on at least.”

1-18. (canceled)

19. A method, comprising:
receiving, at a first user equipment, a call made to a subscriber identity associated with the first user equipment; and
routing, by the first user equipment, the call to a second user equipment to enable the second user equipment to answer the call received from a cellular network, the second user equipment being designated by a controller of a wireless local area network as an active device within the wireless local area network.

20. The method of claim 19, wherein the wireless local area network comprises a home cloud network including the first user equipment and the second user equipment, and wherein the home cloud network allows the first user equipment and the second user equipment to share one or more services available on the home cloud network.

21. A method as in claim 19 further comprising:
designating the second user equipment as the active device based on at least an indication of activity by a user of the second user equipment, wherein the second user equipment lacks an authenticator to directly access the cellular network.

22. The method of claim 21, wherein the designating further comprises:
detecting the indication comprising one or more of the following: a touch screen touch at the second user equipment, a key pad selection at the second user equipment, a screen light being activated at the second user equipment, and data being sent to, or being received from, the cellular network.

23. A method as in claim 19 further comprising:
designating the second user equipment as an idle device based on at least a lack of activity for a predetermined period of time.

24. A method as in claim 19 further comprising:
answering, after the routing, the call at the second user equipment, rather than at the first user equipment.

25. A method as in claim 19 further comprising:
monitoring, by the controller, whether a plurality of user equipment in the wireless local area network change modes between an active mode and an idle mode to enable the controller to designate at least one of the plurality of user equipment as the active device.

26. A method as in claim 19, wherein the routing further comprises:
forwarding the call to the second user equipment via at least one of a direct path and an indirect path, wherein the direct path comprises a wireless link directly between the first user equipment and the second user equipment, and the indirect path comprises a plurality of links via at least one other device.

27. An apparatus comprising:
at least one processor; and
at least one memory including computer program code for one or more programs, the at least one processor, the at least one memory, and the computer program code configured to cause the apparatus to at least:
receive, at a first user equipment, a call made to a subscriber identity associated with the first user equipment; and
route, by the first user equipment, the call to a second user equipment to enable the second user equipment to answer the call received from a cellular network, the second user equipment being designated by a controller of a wireless local area network as an active device within the wireless local area network.

28. The apparatus of claim 27, wherein the wireless local area network comprises a home cloud network including the first user equipment and the second user equipment, and wherein the home cloud network allows the first user equipment and the second user equipment to share one or more services available on the home cloud network.

29. An apparatus as in claim 27 further caused to:
designate the second user equipment as the active device based on at least an indication of activity by a user of the second user equipment, wherein the second user equipment lacks an authenticator to directly access the cellular network.

30. The apparatus of claim 29 further caused to:
detect the indication comprising one or more of the following: a touch screen touch at the second user equipment, a key pad selection at the second user equipment, a screen light being activated at the second user equipment, and data being sent to, or being received from, the cellular network.

31. An apparatus as in claim 27 further caused to:
designate the second user equipment as an idle device based on at least a lack of activity for a predetermined period of time.

32. An apparatus as in claim 27 further caused to:
answer, after the route, the call at the second user equipment, rather than at the first user equipment.

33. An apparatus as in claim 27 further caused to:
monitor, by the controller, whether a plurality of user equipment in the wireless local area network change modes between an active mode and an idle mode to enable the controller to designate at least one of the plurality of user equipment as the active device.

34. An apparatus as in claim 27 further caused to route by:
forward the call to the second user equipment via at least one of a direct path and an indirect path, wherein the direct path comprises a wireless link directly between the first user equipment and the second user equipment, and the indirect path comprises a plurality of links via at least one other device.

35. The apparatus claim of claim 27, wherein the apparatus is comprised in the first user equipment.

36. A non-transitory computer-readable medium encoded with instructions that, when executed by a processor, perform at least the following:
receiving, at a first user equipment, a call made to a subscriber identity associated with the first user equipment; and
routing, by the first user equipment, the call to a second user equipment to enable the second user equipment to answer the call received from a cellular network, the second user equipment being designated by a controller of a wireless local area network as an active device within the wireless local area network.
